(19) United States
(12) Patent Application Publication
(10) Pub. No.: US 2007/0013590 A1
(43) Pub. Date: Jan. 18, 2007

(54) Wide-band antenna, and wide-band antenna mounting substrate

(75) Inventor: Tetsuo Shinkai, Otsu-shi (JP)

Correspondence Address: OSHA LIANG L.L.P., 1221 MCKINNEY STREET, SUITE 2800, HOUSTON, TX, 77010, US

(73) Assignee: OMRON Corporation, Kyoto (JP)

(21) Appl. No.: 11/484,181

(22) Filed: Jul. 11, 2006

(30) Foreign Application Priority Data
Jul. 12, 2005 (JP) 2005-203539

(51) Int. Cl. H01Q 1/24

(52) U.S. Cl. 343/702; 343/700 MS

(57) ABSTRACT

An antenna which can be reduced in size and which can widen the band of a VSWR without changing the shape of a ground pattern but while retaining a wide space for electronic parts to be mounted. The antenna 1 has a feeding electrode portion 4. This feeding electrode portion 4 includes a conductive flat plate, which is cut away at its one corner of a rectangle such that the cut-away portion 15 is defined by an arc joining two sides making a corner and bulging inward.

### BACKGROUND OF THE INVENTION

1. Field of the Invention

The present invention relates to a wide-band antenna for widening the band of VSWR characteristics, and to a wide-band mounting substrate.

2. Background Art

In recent years, the radio communication systems become various and need antennas corresponding to various frequencies, and accordingly a wide-band antenna. In the wide-band antenna, as shown in FIG. 13, a radiative conductor 51 of a semicircular shape is so mounted on a substrate (a GND substrate) 50 having a ground pattern such that its arc center portion (a feeding terminal 52) contacts with the GND substrate 50.

The distance between the radiative conductor 51 and the GND substrate 50 becomes the lager as the closer to the end of the GND substrate 50, so that the antenna can widen the band of VSWR (Voltage Standing Wave Ratio) characteristics.

On the other hand, a radio communication card of the PC card type is used for the radio communications between the mobile telephone and the PC (Personal Computer). This radio communication card has an antenna built therein for the radio communications.

In order to widen the band of an antenna, there is disclosed in Patent Document 1 an antenna, which is intended to widen the band of the VSWR by mounting a tapered ground pattern 63 on a dielectric substrate 62, as shown in FIG. 14, and by arranging a plane element 61 at a suitable position thereby to adjust the distance between the ground pattern 63 and the plane element 61.

Patent Document 1: JP-A-2004-328694 (Laid-Open on Nov. 18, 2004)

### SUMMARY OF THE INVENTION

In the wide-band antenna shown in FIG. 13, however, the radiative conductor 51 has a half-moon shape. Therefore, the antenna has a problem that it is large in its entirety.

On the other hand, the wide-band antenna described in Patent Document 1 is intended to widen the band of the VSWR characteristics by devising the shape of the ground pattern 63. This requires the person having purchased the plane element 61 for designing the shape of the ground pattern 63 especially. This causes a problem of troubles. Moreover, the ground pattern 63 has a tapered shape thereby to cause a problem that the space for the electronic parts to be mounted on the ground pattern 63 is limited.

The present invention has been conceived in view of the problems described above, and has an object to provide an antenna, which can be reduced in size and which can widen the band of a VSWR without changing the shape of a ground pattern (or a grounding electrode) but while retaining a wide space for electronic parts to be mounted, and a wide-band antenna mounting substrate.

In order to solve the aforementioned problems, according to the invention, there is provided a wide-band antenna comprising a feeder, wherein the feeder including a conductive flat plate of a rectangular shape cut away at its one corner such that the cut-away portion is defined by two sides making an angle, and either one straight line joining the two sides or an arc joining the two sides and bulging inward.

In order to solve the aforementioned problems, according to the invention, there is provided a wide-band antenna adapted to be mounted on a substrate having a grounding electrode and comprising a feeder,

wherein the feeder includes a conductive flat plate of a rectangular shape cut away at its one corner such that the cut-away portion is defined by two sides making an angle, and either one straight line joining the two sides or an arc joining the two sides and bulging inward, and

wherein the feeder is so disposed on the end side of the substrate as to confront either the one straight line or the bulging arc in the cut-away portion with respect to the grounding electrode, such that the distance between the grounding electrode and the feeder becomes the longer as the closer to the end portion of the substrate.

In the aforementioned constitution, the shape of the grounding electrode (ground, or ground pattern) is not designed. This makes it unnecessary to perform the troublesome work to change the shape of the grounding electrode. Moreover, the grounding electrode is not tapered unlike the prior art, so that the space (the space for the grounding electrode) for mounting the electronic parts can be enlarged.

Moreover, the feeder includes a conductive flat plate of a rectangular shape cut away at its one corner such that the cut-away portion is defined by two sides making an angle, and either one straight line joining the two sides or an arc joining the two sides and bulging inward. Therefore, the shape is formed into substantially one half of the semicircle. As a result, the antenna can be reduced to one half of the size of the prior art, as has been described hereinbefore. Thus, the antenna can be reduced in size.

Even with this size reduction, moreover, the single straight line or the bulging arc in the cut-away portion is made to confront the grounding electrode so that the distance between the grounding electrode and the feeder becomes the longer as the closer to the end portion of the substrate, thereby the VSWR characteristics can be made wider in band. Moreover, we have found it after keen investigations that the VSWR characteristics can be made further wider in band by mounting the feeder on the end portion of the substrate.

In the wide-band antenna of the invention, it is preferred that the feeder is covered with a dielectric member of a flat plate shape.

According to this constitution, the feeder is covered with the dielectric member of the flat plate shape. As a result, this dielectric member has an effect, as called the wavelength shortening effect, that the antenna virtually has a function equivalent to that of an antenna having a size larger than that of a practical one. As a result, it is possible to acquire the VSWR characteristics of a wide band without enlarging the size of the antenna.

In the wide-band antenna of the invention, moreover, it is preferred that an electric feeding terminal is disposed on one of the angle-making two sides outside of the dielectric member.

In the wide-band antenna of the invention, moreover, it is preferred that the feeding terminal projects normal to the flat face of the dielectric member such that the projecting portion is folded in an L-shape.

According to the aforementioned constitution, the feeding terminal projects normal to the flat face of the dielectric member such that the projecting portion is folded in an L-shape. This makes it possible to mount the dielectric member easily on the substrate.

In the wide-band antenna of the invention, moreover, it is preferred that fixing terminals are disposed outside of the dielectric member one by one on the two shoulders of the side confronting the one side having the feeding terminal mounted thereon.

According to the aforementioned constitution, the fixing terminals are disposed outside of the dielectric member one by one on the two shoulders of the side confronting the one side having the feeding terminal mounted thereon.

In the wide-band antenna of the invention, moreover, it is preferred that the fixing terminals have portions projecting in the same direction and to the same height as those of the feeding terminals and folded in the L-shape.

According to the aforementioned constitution, the fixing terminals have portions projecting in the same direction and to the same height as those of the feeding terminals and folded in the L-shape, so that the dielectric member can be easily mounted on the substrate.

In the wide-band antenna of the invention, moreover, it is preferred that a projection projecting in the same direction and to the same height as those of the protruding portions is disposed at the portion, as corresponding to the cut-away portion, in the dielectric member.

The feeding terminals are mounted on the two shoulders of one side, as described hereinbefore, but the side having the feeding terminals has the cut-away portion so that the feeding terminals are mounted while avoiding the cut-away portion. When the antenna is mounted on the substrate, the three points project, but the cut-away portion does not project. Therefore, this is an unstable mounting method, because the antenna rattles with respect to the substrate. According to the aforementioned constitution, however, the projection projecting in the same direction and to the same height as those of the protruding portions is disposed at the portion, as corresponding to the cut-away portion, in the dielectric member. As a result, the antenna can be stably mounted on the substrate without any rattling.

In the wide-band antenna of the invention, moreover, it is preferred that the feeding terminal extends in parallel with the flat face of the feeder.

According to the aforementioned constitution, the feeding terminal extends in parallel with the flat face of the feeder. As a result, the antenna can be arranged normal to the substrate. It is, therefore, possible to widen the width of directivity and to use the feeding terminal as the through-hole terminal.

In the wide-band antenna of the invention, moreover, it is preferred that the feeder and the dielectric member are molded monolithically with each other by an insert-molding method.

According to the aforementioned constitution, the feeder and the dielectric member are molded monolithically with each other by the insert-molding method. As a result, the antenna can be easily manufactured to enhance its mass productivity.

In the wide-band antenna of the invention, moreover, it is preferred that the dielectric member is made of a high dielectric constant resin or high dielectric constant ceramics.

In the wide-band antenna of the invention, moreover, it is preferred that the feeder is disposed on the two faces of a supporting member of a flat plate shape such that the feeders on the two faces are connected to each other.

According to the aforementioned constitution, the feeder is disposed on the two faces of a supporting member of a flat plate shape such that the feeders on the two faces are connected to each other. Thus, the feeders are disposed on the two faces of the supporting member of the flat plate shape. If one feeder is prepared, therefore, it can be mounted on either of the two ends of the substrate. Moreover, the feeders on the two faces are connected to each other so that they can be mounted not only in parallel with the substrate but also normal to the substrate. Thus, it is possible to provide an antenna matching the desired directivity.

In the wide-band antenna of the invention, moreover, it is preferred that the supporting member is made of a dielectric material.

According to the aforementioned constitution, the supporting member is made of a dielectric material. As a result, the size of the antenna can be reduced by the wavelength shortening effect.

In the wide-band antenna mounting substrate of the invention, it is preferred that a wide-band antenna according to any of the foregoing constitutions is mounted.

According to the invention, as has been described hereinbefore, there is provided a wide-band antenna comprising a feeder, wherein the feeder including a conductive flat plate of a rectangular shape cut away at its one corner such that the cut-away portion is defined by two sides making an angle, and either one straight line joining the two sides or an arc joining the two sides and bulging inward.

According to the invention, as has been described hereinbefore, there is provided a wide-band antenna adapted to be mounted on a substrate having a grounding electrode and comprising a feeder, wherein the feeder including a conductive flat plate of a rectangular shape cut away at its one corner such that the cut-away portion is defined by two sides making an angle, and either one straight line joining the two sides or an arc joining the two sides and bulging inward, and wherein the feeder is so disposed on the end side of the substrate as to confront either the one straight line or the bulging arc in the cut-away portion with respect to the grounding electrode, such that the distance between the grounding electrode and the feeder becomes the longer as the closer to the end portion of the substrate.

Therefore, the invention has an advantage to provide the antenna, which can be reduced in size and which can widen the band of the VSWR without changing the shape of the ground pattern (or the grounding electrode) but while retaining the wide space for electronic parts to be mounted.

### BRIEF DESCRIPTION OF THE DRAWINGS

FIG. 1 shows a mode of embodiment of the invention and is a perspective view showing a schematic constitution of an antenna;

FIG. 2 is a perspective view showing the schematic constitution of the antenna shown in FIG. 1;

FIG. 3 is a perspective view showing an antenna mounting substrate mounting the antenna shown in FIG. 2;

FIGS. 4A to 4F are diagrams showing the mode of embodiment of the invention, and show a method for manufacturing the antenna;

FIG. 5 is a graph showing VSWR characteristics at the time when the size of the antenna and the mounting position on the substrate are changed;

FIGS. 6A to 6D are diagrams showing the analysis results of radiation characteristic analyses of the antenna;

FIG. 7 is a perspective view showing the back of the antenna shown in FIG. 2;

FIG. 8 is a perspective view showing an antenna of another mode of embodiment of the invention;

FIG. 9 is a perspective view showing an antenna mounting substrate mounting the antenna shown in FIG. 8;

FIGS. 10A to 10D are diagrams showing the analysis results of radiation characteristic analyses of the antenna;

FIG. 11 is a perspective view showing an antenna of still another mode of embodiment of the invention;

FIGS. 12A and 12B are perspective views showing an antenna mounting substrate mounting the antenna shown in FIG. 11;

FIG. 13 is an explanatory view showing an antenna of the prior art; and

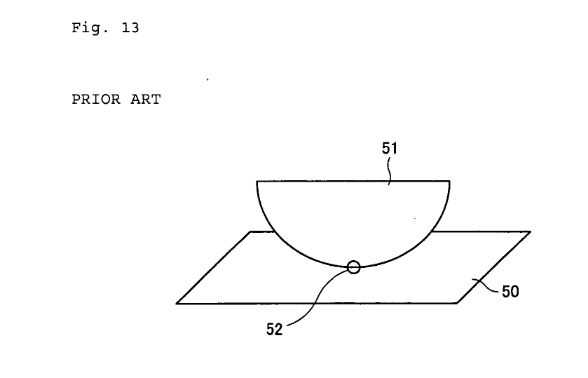

FIG. 14 is an explanatory view showing an antenna of the prior art.

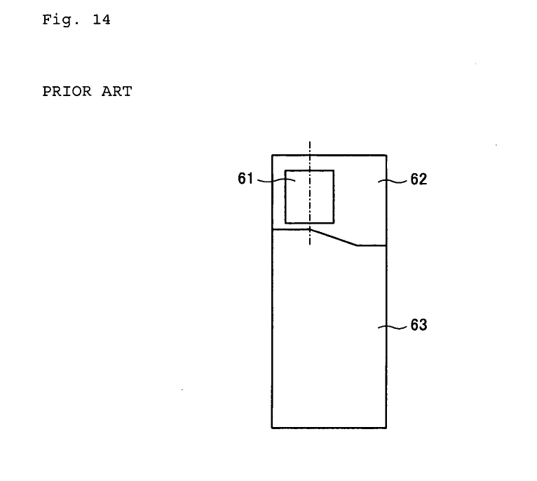

### DESCRIPTION OF THE PREFERRED EMBODIMENTS

### Mode 1 of Embodiment

One mode of embodiment of the invention is described with reference to the accompanying drawings.

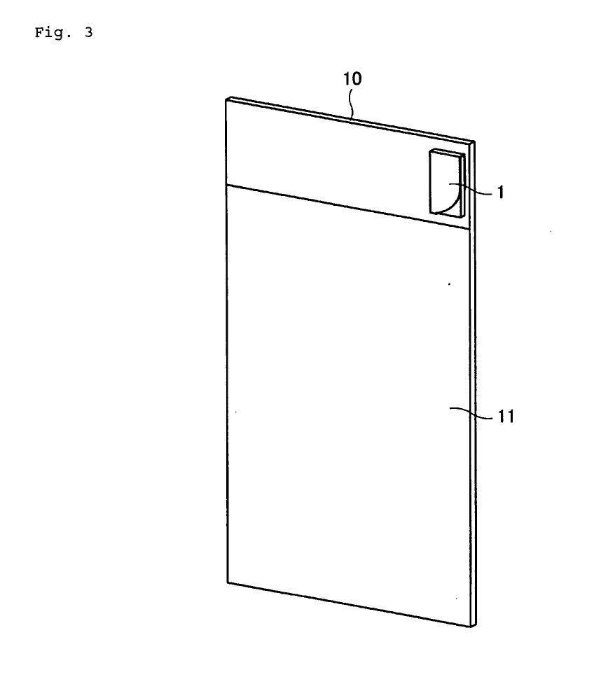

FIG. 3 is a perspective view showing an antenna mounting substrate of this mode of embodiment. This antenna mounting substrate is provided, as shown in FIG. 3: a substrate (a wide-band antenna mounting substrate) 10, an antenna (a wide-band antenna) 1 mounted on the substrate 10, and a ground pattern (a grounding electrode) 11. This antenna mounting substrate is further provided with the not-shown high-frequency power source and the not-shown feeding lines. The substrate 10 has a role as a base for the antenna 1 and the ground pattern 11, and is made of a resin substrate of FR-4, Teflon (known under the registered trademark) or the like. The ground pattern 11 has a role to secure the function of the antenna 1.

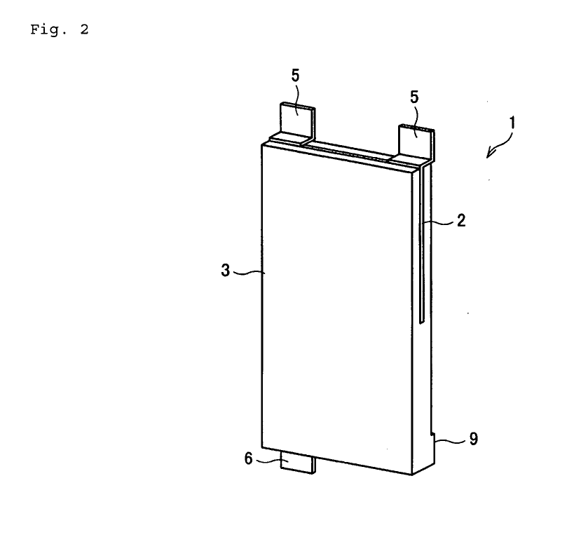

FIG. 2 is a perspective view showing the schematic constitution of the antenna 1. This antenna 1 is a chip antenna, i.e., an antenna having a chip shape (or a flat shape), as shown in FIG. 2. This chip antenna can be made lower and smaller than the monopole antenna. As shown, moreover, the antenna 1 is formed to have a flat shape contour by a dielectric substrate 3 to act as the later-described dielectric.

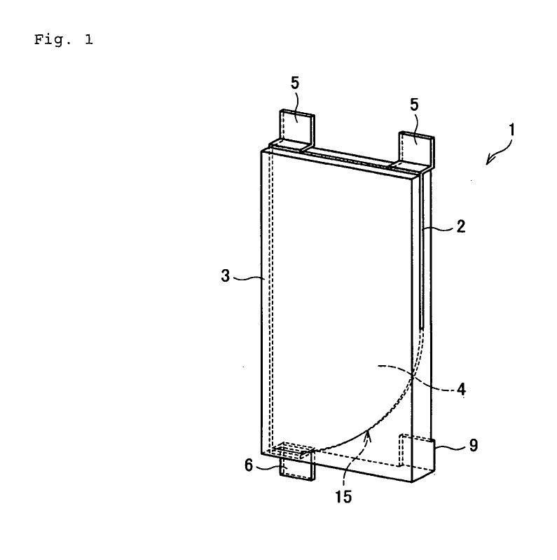

FIG. 1 is a perspective view showing the schematic constitution of the antenna 1 shown in FIG. 2. As shown in FIG. 1, the antenna 1 is provided with a feeding conductor 2 and the dielectric substrate 3 made of a resin for a high dielectric constant, high dielectric ceramics or the like.

The feeding conductor 2 performs an antenna function together with the ground pattern 11, and is provided with a feeding electrode portion 4 (a feeder, a sector-shaped radiating element portion, or a radiating electrode portion) 4, fixing surface-mounting terminal portions (fixing terminals, or fixing terminal portions) 5, and a fixing surface-mounting terminal portion (a feeding terminal, or a feeding terminal portion) 6. The feeding conductor 2 is clamped by the dielectric substrate 3, as shown in FIG. 1. Of the feeding conductor 2, the feeding electrode portion 4 is sheathed (covered) with the dielectric substrate 3, but the fixing terminal portions 5 and the feeding terminal portion 6 are exposed to the outside of the dielectric substrate 3.

The feeding electrode portion 4 is a flat electrode made of a conductor (e.g., a metallic material). This feeding electrode portion 4 is shaped such that a flat plate of a rectangular shape having two sets (two pairs) of shorter and longer opposite sides is so cut at its one corner as to bulge (or to curve) outward (as this curving portion will be called a cut-away portion 15). In short, the flat shape of the feeding electrode portion 4 has three rectangular angles and one bulging angle. However, the cut-away portion 15 bulges but may also be straight. Moreover, the rectangular shape of the flat plate should not be limited to that shape but may also be a square shape.

In other words, the feeding electrode portion 4 is made of a conductive flat plate, and this flat plate is cut away at its one rectangular corner such that the cut-away portion is defined by two sides making the corner and either one straight lines joining the two sides or an arc bulging inward of the two sides.

The fixing terminal portions 5 are flat electrodes made of a conductor (e.g., a metallic material), and have a role to fix the antenna 1 on the substrate 10. The fixing terminal portions 5 are so mounted on the two shoulders of the shorter side, as not having the cut-away portion 15, of the rectangular feeding electrode portion 4 as protrudes longitudinally of the dielectric substrate 3.

The fixing terminal portions 5 are preferred to have a bent structure (e.g., a folded structure of an L-shape) so that the antenna 1 may be easily mounted on the surface. More specifically, the fixing terminal portions 5 project at a right angle from the flat face of the dielectric substrate 3 such that the projecting portions are preferably folded in the L-shape. In this mode of embodiment, the fixing terminal portions 5 are bent outward with respect to the dielectric substrate 3. However, the fixing terminal portions 5 should not be limited thereto but may also be bent inward with respect to the dielectric substrate 3.

With the bent constitution of the fixing terminal portions 5, the antenna 1 can be mounted on the surface of the substrate 10 thereby to improve the mass productivity of the antenna mounting substrate (FIG. 3). However, the constitution of the fixing terminal portions 5 should not be limited to the bent one but may be any, if it can mount the antenna 1 on the surface of the substrate 10. Moreover, the means for mounting the antenna 1 on the substrate 10 should not be limited to the fixing terminal portions 5 but may also be another.

The feeding terminal portion 6 is an electrode having a shape of a flat plate made of a conductor (e.g., a metallic material), and has a role to fix the antenna 1 on the substrate 10 and a role to feed (an electric power) to the antenna 1 through the not-shown feeding lines. The feeding terminal portion 6 is disposed on the shorter side, as having the cut-away portion 15, of the feeding electrode portion 4 of the rectangular shape such that it projects outward of the dielectric substrate 3 in the longitudinal direction of the dielectric substrate 3. This feeding terminal portion 6 has a bent constitution like the aforementioned fixing terminal portions 5. Specifically, the feeding terminal portion 6 is preferred to have a portion projecting in the same direction and to the same height as those of the fixing terminal portions 5 and to be folded in the L-shape apart from the dielectric substrate 3. Like the aforementioned fixing terminal portions 5, however, the feeding terminal portion 6 should not always be limited to the bent constitution.

The dielectric substrate 3 is given a function to reduce the size of the antenna by a wavelength shortening effect. However, the dielectric substrate 3 is not an essential constituent, but the antenna 1 without the dielectric substrate 3 is also contained in the technical range of this mode of embodiment.

On the other hand, the dielectric substrate 3 is preferably made of a resin, for example. This resin can be exemplified by polyphenylene sulfide (PPS), a liquid crystal polymer (LCP), syndiotactic polystyrene (SPS), polycarbonate (PC), polyethylene terephthalate (PET), an epoxy resin (EP), a polyether imide resin (PEI) or a phenolic resin (PF). Moreover, the dielectric substrate 3 is also preferably made of a resin having a high dielectric constant or ceramics having a high dielectric constant.

Moreover, the aforementioned PPS or LCP is excellent in heat resistance, sizing stability, and molding/working characteristics. Moreover, the specific dielectric constant of the dielectric substrate 3 can be set within a range of 5 to 20.

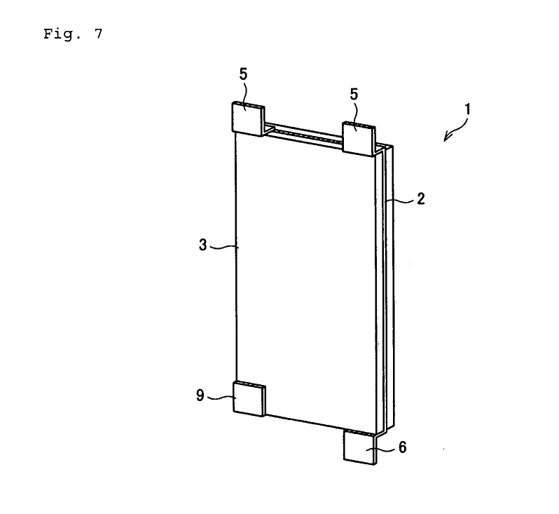

Here, the dielectric substrate 3 is provided with a projection 9 at one of its four corners (as referred to FIG. 1, FIG. 2 and FIG. 7), although the function and so on of the projection 9 will be described in detail.

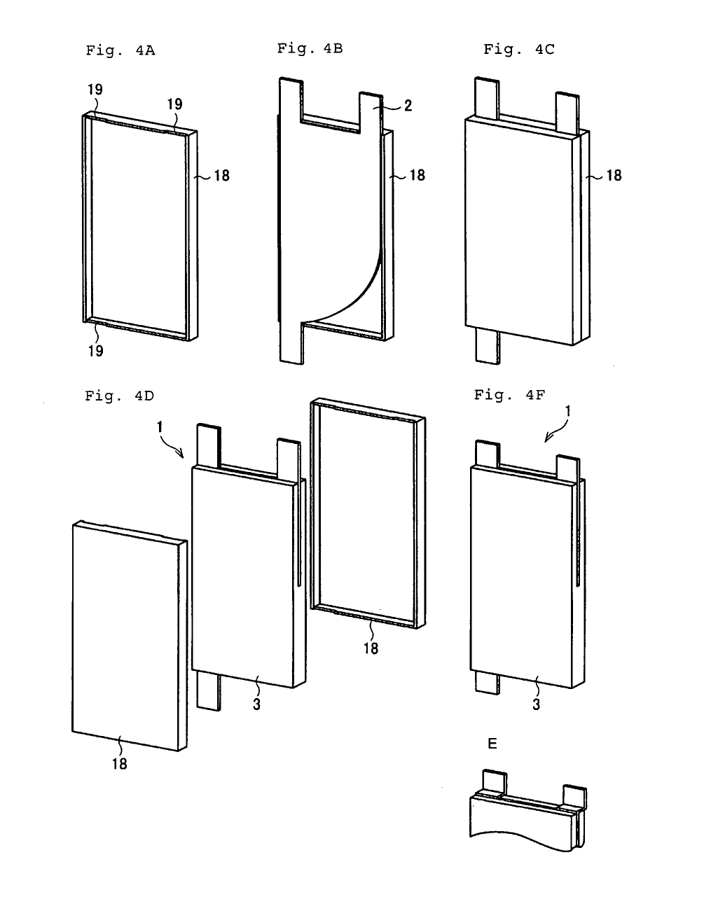

Next, a method for manufacturing the antenna 1 is described with reference to FIG. 4A to FIG. 4F. The antenna 1 is preferably manufactured by an insert-molding method. Here in the insert-molding method, a material is injected into a mold and is monolithically molded in the mold. However, the method for manufacturing the antenna 1 should not be limited to the insert-molding method, but may also be exemplified by an extrusion molding method or an injection molding method.

The manufacture of the antenna 1 by this insert-molding method uses a mold having a chip shape to mold the feeding conductor 2 and the dielectric substrate 3 monolithically. This mold is provided with three terminal positioning portions (or recessed portions) 19, as shown in FIG. 4A. The provision of the terminal positioning portions 19 makes it possible to position the fixing terminal portions 5 and the feeding terminal portion 6 with the feeding electrode portion 4. In short, the terminal positioning portions 19 have a role to position the feeding conductor 2.

Here, the terminal positioning portions 19 should not be limited to the aforementioned recessed portions. For example, the fixing terminal portions 5 and the feeding terminal portion 6 may also be positioned with the feeding electrode portion 4 by forming rod-shaped projections at predetermined positions and by bringing the fixing terminal portions 5 and the feeding terminal portion 6 into contact with the feeding electrode portion 4.

Thus, a mold 18 is provided with the terminal positioning portions 19 so that the feeding conductor 2 can be disposed at the precise position of the mold 18, as shown in FIG. 4B, thereby to mold the feeding conductor 2 and the dielectric substrate 3 monolithically in high precision.

After positioned in the mold 18, the feeding conductor 2 is clamped on its two sides between the two molds 18, as shown in FIG. 4C. Then, the dielectric material for the dielectric substrate 3 is injected into the not-shown injection port disposed in the molds 18 thereby to integrate the dielectric substrate 3 and the feeding conductor 2.

As a result, the feeding conductor 2 and the dielectric substrate 3 are monolithically molded, as shown as exploded perspective views in FIG. 4D. Then, the fixing terminal portions 5 and the feeding terminal portion 6 are cut to desired lengths, as shown in FIG. 4E. Finally, the fixing terminal portions 5 and the feeding terminal portion 6 are bent, as shown in FIG. 4F. Here, the fixing terminal portions 5 and the feeding terminal portion 6 maybe bent, after cut to the desired lengths, and may then be subjected to the processes shown in FIG. 4A to FIG. 4C.

Here are described the constitution of the antenna 1 and the position of the antenna 1 on the substrate 10, which constitute the most important portion of the invention.

The antenna 1 of this mode of embodiment is especially disposed on the end side of the substrate 10; the substrate 10 is provided on its end side with the cut-away portion 15 of the feeding electrode portion 4 and formed at its central side into the rectangular shape; and the distance between the ground pattern 11 and the feeding electrode portion 4 becomes the longer as the cut-away portion 15 comes the closer to the end portion of the substrate 10. We have found out that the aforementioned constitution can widen the band of the VSWR (Voltage Standing Wave Ratio). The reason for this band widening of the VSWR will be described hereinafter by using experimental data.

Moreover, the feeding electrode portion 4 is provided with the cut-away portion 15 so that the feeding electrode portion 4 (or the antenna 1) can be made smaller than the semicircular feeding electrode portion 4 of the prior art.

Moreover, the band of the VSWR can be widened without changing the constitution of the ground pattern 11 so that the ground maker having purchased the antenna is not compelled to design the ground pattern.

Moreover, the constitution of the ground pattern 11 need not be changed so that the ground pattern 11 can take a wide area. Thus, the ground pattern 11 can mount more electronic parts (although not shown). Here, the (not-shown) electronic parts affect the antenna characteristics adversely, if they are mounted on the place having no ground pattern 11. This problem can be solved according to the antenna mounting substrate of this mode of embodiment.

As described above, the antenna 1 is disposed on the end of the substrate 10; the substrate 10 is provided on its end side with the cut-away portion 15 of the feeding electrode portion 4 and formed at its central side into the rectangular shape; and the distance between the ground pattern 11 and the feeding electrode portion 4 becomes the longer (or larger) as the closer to the end portion of the substrate 10. We have made keen investigations and have found out that the constitution can widen the band of the VSWR. The experimental data are explained.

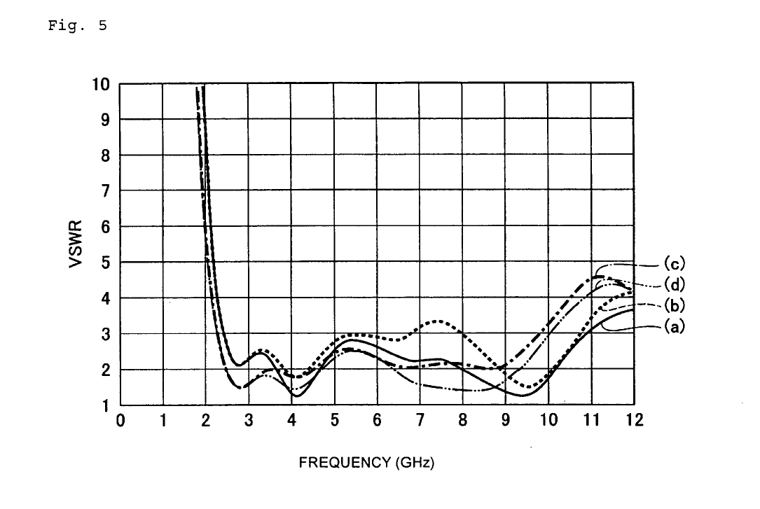

In these experiments, two antennas 1 having sizes of 10×5×1 (mm) and 10×10×1 (mm) were used, as shown in FIG. 5, and the VSWR characteristics were examined on the cases, in which the individual antennas 1 were arranged at the central (or center) portion and at the end of the substrate 10. In FIG. 5, the cut-away portion 15 of the feeding electrode portion 4 was disposed on the end side of the substrate 10, the center side of the substrate 10 is formed into a rectangular shape. At the same time, the cut-away portion 15 is formed such that the distance between the ground pattern 11 and the feeding electrode portion 4 is spaced the more as it comes the closer to the end portion of the substrate 10.

In FIG. 5, moreover: the waveform (a) shows the VSWR characteristics of the antenna 1 having the sizes of 10×5×1 (mm) and arranged on the end of the substrate 10; the waveform (b) shows the VSWR characteristics of the antenna 1 having the sizes of 10×5×1 (mm) and arranged at the center of the substrate 10; the waveform (c) shows the VSWR characteristics of the antenna 1 having the sizes of 10×10×1 (mm) and arranged at the center of the substrate 10; and the waveform (d) shows the VSWR characteristics of the antenna 1 having the sizes of 10×10×1 (mm) and arranged at the end of the substrate 10.

The waveform (a) and the waveform (b) are compared. It is then seen from FIG. 5 that the frequency band for the VSWR of 3 or less is wider for the waveform (a). Especially within the frequency of 7 (GHz) to 8 (GHz), the waveform (a) has a VSWR of 3 or less whereas the waveform (b) has a VSWR of 3 or more. It is, therefore, found on the antenna 1 having the sizes of 10×5×1 (mm) that the band can be widened for the arrangement on the end of the substrate 10 (i.e., for the waveform (a).

Next, the waveform (c) and the waveform (d) are compared. It is then seen from FIG. 5 that the frequency band for the VSWR of 3 or less is wider for the waveform (d). Especially within the frequency of 7 (GHz) to 9 (GHz), the waveform (d) has a less VSWR than the waveform (c). It is, therefore, found on the antenna 1 having the sizes of 10×10×1 (mm) that the band can be widened for the arrangement on the end of the substrate 10 (i.e., for the waveform (d).

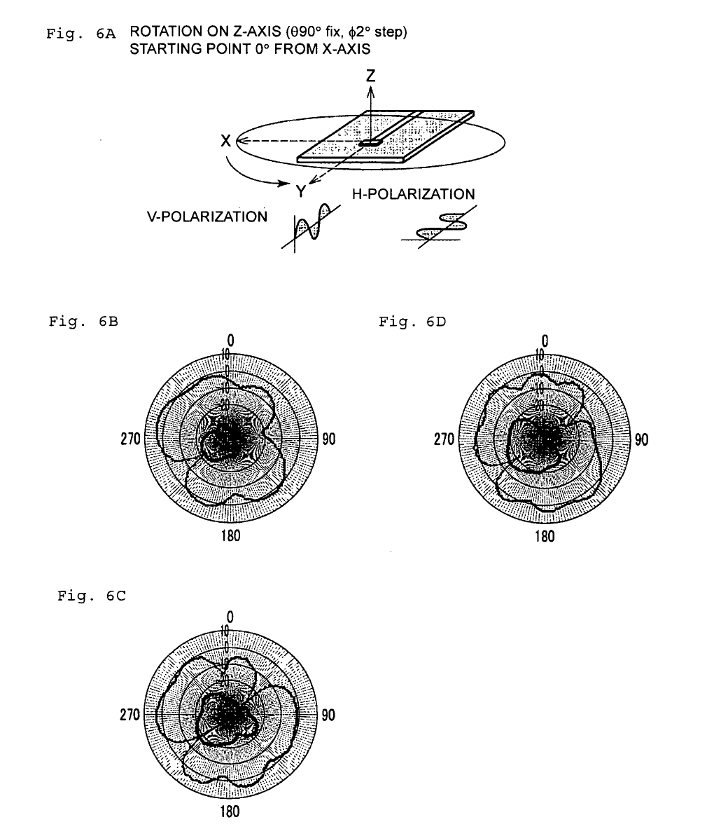

FIG. 6A to FIG. 6D show the results of the measurements of distant interface radiation characteristic gains to become directive indices by rotating the antenna 1 of this mode of embodiment horizontally after the antenna 1 was mounted on the substrate 10. In FIG. 6B to FIG. 6D, the numerical values 0, 90, 180 and 270, as indicated in the circumferential portions, designate the angles of horizontal rotation after the antenna 1 was mounted on the substrate 10. Here, the angles of rotation indicate the positional relations between the front direction after the antenna 1 was mounted on the substrate 10 and the (not-shown) device for measuring the distant interface radiation characteristics.

In this example, at the rotation (z) on the Z-axis, the X-axis on the X-Y plane is located at the point of 0 degrees at the rotation start, and the measurement device is rotated by 90 degrees in the direction of arrow of the Y-axis so that it reaches the Y-axis. On the other hand, the numerical values, as indicated on the radii of the circle, designate the distant interface radiation characteristic gains. The measurements are made for the frequency of 3.1 GHz (FIG. 6B), 4 GHz (FIG. 6C) and 4.9 GHz (FIG. 6D).

It is seen from FIGS. 6A to 6D that the antenna 1 of this mode of embodiment has high frequency gains in the H (horizontal) polarizations.

FIG. 7 is a perspective view showing the antenna 1 shown in FIG. 2, from the back.

The fixing terminal portions 5 and the feeding terminal portion 6 are so projected from the face of the dielectric substrate 3 as to fix the antenna 1 on the substrate 10 (FIG. 3), as shown in FIG. 7. On the contrary, the portion of the dielectric substrate 3, as corresponding to the cut-away portion of the feeding conductor 2 is not provided with any terminal such as the fixing terminal portions 5 or the feeding terminal portion 6 so that it has no projection. As a result, the antenna 1 is mounted at its three points on the substrate 10 so that it rattles to invite instability.

In order to prevent the instability, the projection 9 having the same height as that of the fixing terminal portions 5 and the feeding terminal portion 6 is preferably disposed at the portion, as corresponding to the cut-away portion of the feeding conductor 2, of the dielectric substrate 3. As a result, the antenna 1 can be prevented, when it is mounted on the substrate 10, from rattling to invite the instability with respect to the substrate 10.

### Mode 2 of Embodiment

An antenna of another mode of embodiment is described. For convenience of description, the members having functions similar to those of the members described in the mode 1 of embodiment are omitted in their description by designating them by the common reference numerals.

In the foregoing mode 1 of embodiment, the antenna 1 is mounted on the substrate 10 such that the largest area face of the surface of the antenna 1 confronts the face of the substrate 10. In short, the antenna 1 is arranged in parallel with the substrate 10. In the foregoing mode, therefore, the feeding terminal portion 6 is so bent that it may be easily mounted face-to-face on the substrate 10.

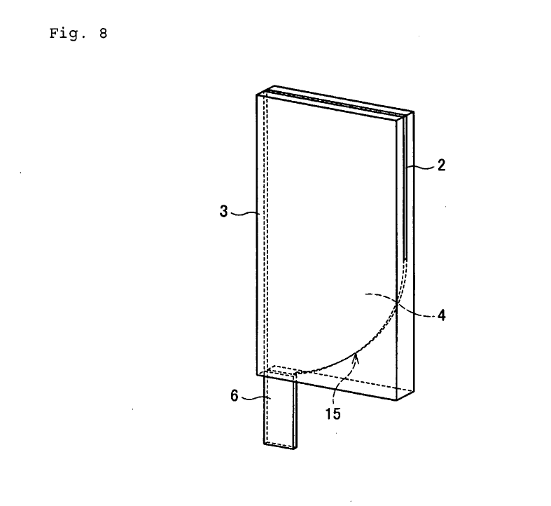

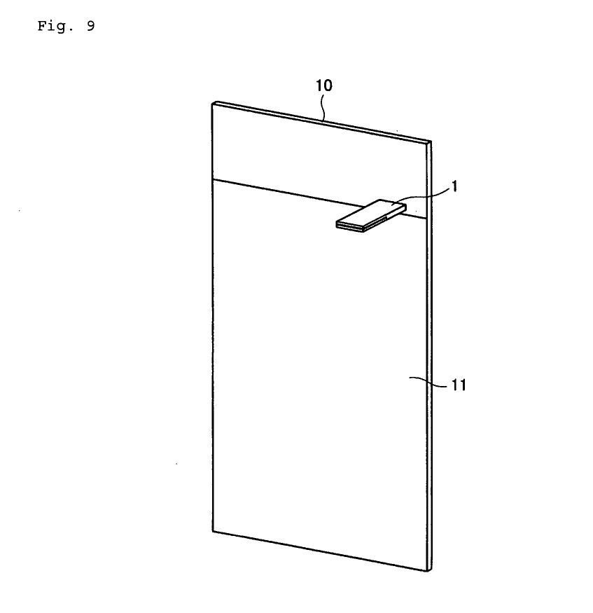

However, the constitution should not be limited to the bent one, but the antenna 1 may also be mounted on the substrate 10 such that the face having the feeding terminal portion 6 (or the face having the projection of the feeding terminal portion 6) confronts the face of the substrate 10. In short, the antenna 1 may be arranged normal to the substrate 10. In this case, it is preferred that the feeding terminal portion 6 is not bent but held straight, as shown in FIG. 8. As shown in FIG. 9, therefore, it is sufficient to pierce the straight feeding terminal portion 6 into the substrate 10. Therefore, the antenna 1 can be used as the through-hole terminal and can be arranged normal to the substrate 10.

In case the antenna 1 is arranged normal to the substrate 10, like the foregoing mode 1 of embodiment, the antenna 1 is disposed on the end side of the substrate 10, as shown in FIG. 9; the substrate 10 is provided on its end side with the cut-away portion 15 of the feeding electrode portion 4 and formed at its central side into the rectangular shape; and the distance between the ground pattern 11 and the feeding electrode portion 4 becomes the longer as the cut-away portion 15 comes the closer to the end portion of the substrate 10. As a result, the band of the VSWR can be widened like the mode 1 of embodiment.

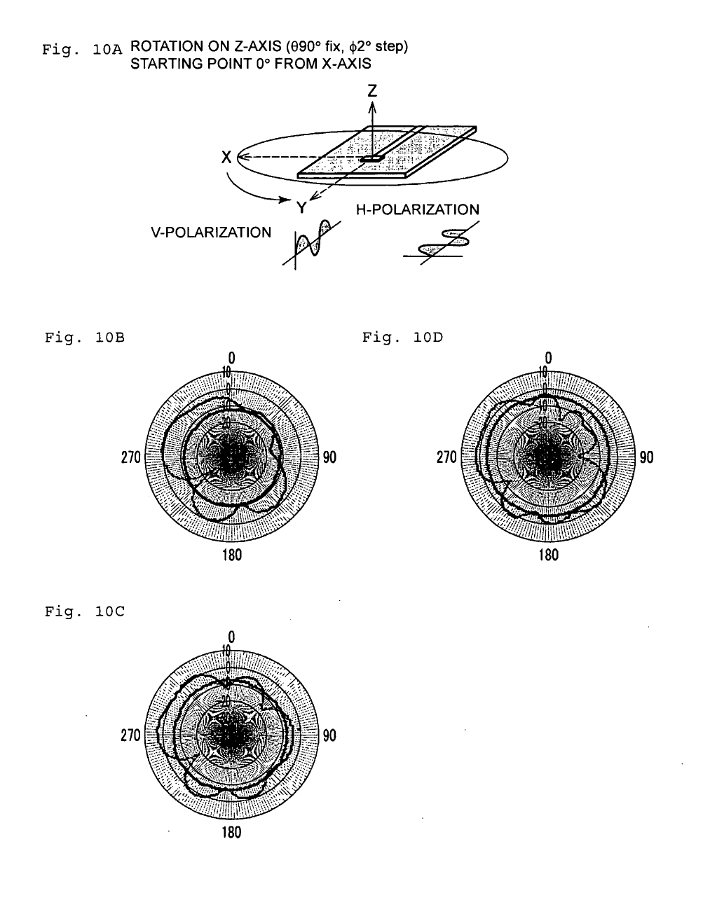

In case the antenna 1 is arranged normal to the substrate 10, moreover, its pattern of directivity is changed to improve the V-polarization (the vertical polarization). This point is described with reference to FIG. 10A to FIG. 10D.

FIG. 10A to FIG. 10D show the results of the measurements of distant interface radiation characteristic gains to become directive indices by rotating the antenna 1 of this mode of embodiment horizontally after the antenna 1 was mounted on the substrate 10. In FIG. 10B to FIG. 10D, the numerical values 0, 90, 180 and 270, as indicated in the circumferential portions, designate the angles of horizontal rotation after the antenna 1 was mounted on the substrate 10. Here, the angles of rotation indicate the positional relations between the front direction after the antenna 1 was mounted on the substrate 10 and the (not-shown) device for measuring the distant interface radiation characteristics.

In this example, at the rotation (z) on the Z-axis, the X-axis on the X-Y plane is located at the point of 0 degrees at the rotation start, and the measurement device is rotated by 90 degrees in the direction of arrow of the Y-axis so that it reaches the Y-axis. On the other hand, the numerical values, as indicated on the radii of the circle, designate the distant interface radiation characteristic gains. In FIGS. 10B to 10D, the V-polarization is indicated by a thick line and the H-polarization is indicated by a thin line. The measurements are made for the frequency of 3.1 GHz (FIG. 10B), 4 GHz (FIG. 10C) and 4.9 GHz (FIG. 10D).

It is seen from FIGS. 10A to 10D that the antenna 1 of this mode of embodiment has high frequency gains in the V (vertical) polarizations.

In this mode of embodiment, the antenna 1 is so disposed normal to the substrate 10 that its feeding terminal portion 6 confronts the substrate 10. Therefore, this mode of embodiment does not need the fixing terminal portions 5, as exemplified in the foregoing mode 1 of embodiment. As a result, it is possible to reduce the cost and to enhance the mass productivity of the antenna 1. Moreover, the constitution may be modified such that the direction of mounting the antenna 1 on the substrate 10 is changed (to switch the mode 1 of embodiment and this mode of embodiment) by making it possible to mount the fixing terminal portions 5 in the foregoing mode 1 of embodiment. As a result, the antenna 1 can be used to match the desired directivity.

The antenna 1 of this mode of embodiment can also be manufactured like the foregoing mode 1 of embodiment by the insert-molding method using the mold 18 (as referred to FIG. 4A to FIG. 4F). Since the antenna of this mode of embodiment does not need the fixing terminal portions 5, however, the terminal positioning portions 19 in the mold 18 may be only one.

### Mode 3 of Embodiment

An antenna of still another mode of embodiment is described. For convenience of description, the members having functions similar to those of the members described in the modes 1 and 2 of embodiment are omitted in their description by designating them by the common reference numerals.

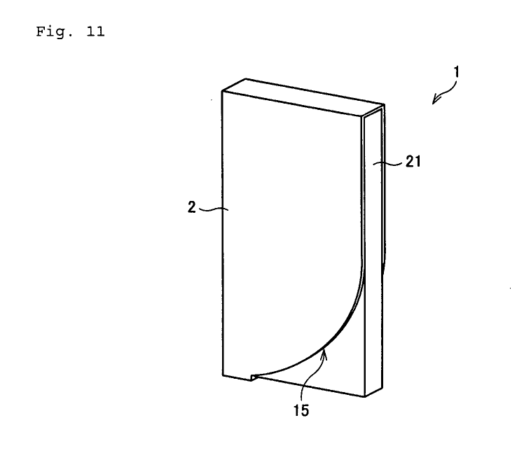

In both the aforementioned modes of embodiment, the feeding conductor 2 is clamped in the dielectric substrate 3. However, the constitution should not be limited to those modes, but the feeding conductor 2 may also be disposed on the surface of a dielectric substrate (a supporting member) 21, as shown in FIG. 11. Here, the supporting member is exemplified by the dielectric substrate 21. In this mode of embodiment, however, the supporting member need not have the dielectric property, but may be any if it can support the feeding electrode portion 4 of the feeding conductor 2. However, the dielectric substrate 21 is preferably made of a dielectric resin. If the dielectric substrate 21 is made of the dielectric resin, the antenna size can be reduced by the wavelength shortening effect.

More specifically, feeding electrode portions (radiative electrodes) 4 having a shape similar to that of the aforementioned feeding electrode portion 4 are preferably mounted on the two faces of the dielectric substrate 21 having a chip shape (or a flat shape). The feeding electrode portions 4 on the two faces of the dielectric substrate 21 are preferably connected (jointed) on the upper face and the lower face of the dielectric substrate 21.

The antenna 1 of this mode of embodiment can be manufactured, unlike the foregoing modes of embodiment, by adhering the feeding conductor 2 to the dielectric substrate 21 not by the insert-molding method but by the so-called “MID (Molded Interconnection Device) method. Here, the MID method is to mold an electric circuit with copper or another metal on a stereoscopically molded insulator of a resin or ceramics.

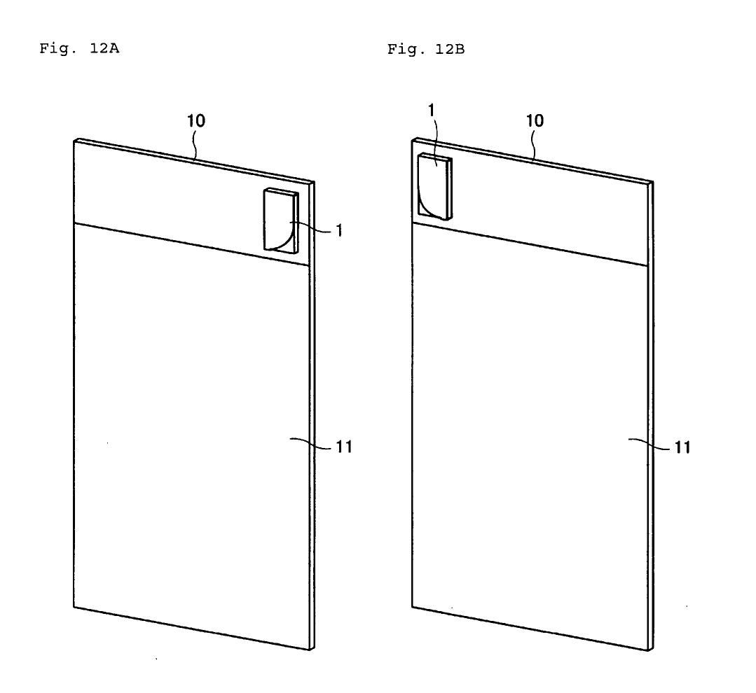

In case the antennas 1 of this mode of embodiment are to be mounted in parallel on the substrate 10, as shown in FIGS. 12A and 12B, the feeding conductor 2 is exposed to the outer side so that the feeding terminal portion 6 of the mode 1 of embodiment can be eliminated to enhance the mass productivity of the antenna 1.

Moreover, the antenna 1 of this mode of embodiment can be mounted on either of the two ends of the substrate 10, as shown in FIGS. 12A and 12B, by turning it inside out. Moreover, the feeding electrode portions 4 on the two faces of the dielectric substrate 21 are connected on the upper face and the lower face of the dielectric substrate 21. Therefore, these connected portions play the feeding function so that the antenna 1 can be mounted, like the mode 2 of embodiment, normal to the substrate 10. In short, the directivity is wider in versatility than those of any of the foregoing modes of embodiment.

The invention should not be limited to the aforementioned individual modes of embodiment, but can be modified in various manners within the scope defined by claims. The technical concept of the invention covers the embodiments that are obtained by suitably combining the technical means disclosed in the different modes of embodiment.

The chip antenna of the invention can be properly used as a radio communication card capable of communicating with a mobile telephone, a mobile built-in antenna, a radio LAN antenna, and an RF-ID antenna.

What is claimed is:

1. A wide-band antenna comprising a feeder,
wherein said feeder including a conductive flat plate of a rectangular shape cut away at its one corner such that said cut-away portion is defined by two sides making an angle, and either one straight line joining said two sides or an arc joining said two sides and bulging inward.

2. A wide-band antenna according to claim 1,
wherein said feeder is covered with a dielectric member of a flat plate shape.

3. A wide-band antenna according to claim 2,
wherein an electric feeding terminal is disposed on one of said angle-making two sides outside of said dielectric member.

4. A wide-band antenna according to claim 3,
wherein said feeding terminal projects normal to the flat face of said dielectric member such that said projecting portion is folded in an L-shape.

5. A wide-band antenna according to claim 4,
wherein fixing terminals are disposed outside of said dielectric member one by one on the two shoulders of the side confronting said one side having said feeding terminal mounted thereon.

6. A wide-band antenna according to claim 5,
wherein said fixing terminals have portions projecting in the same direction and to the same height as those of said feeding terminals and folded in the L-shape.

7. A wide-band antenna according to claim 6,
wherein a projection projecting in the same direction and to the same height as those of said protruding portions is disposed at the portion, as corresponding to said cut-away portion, in said dielectric member.

8. A wide-band antenna according to claim 3,
wherein said feeding terminal extends in parallel with the flat face of said feeder.

9. A wide-band antenna according to claim 1,
wherein said feeder and said dielectric member are molded monolithically with each other by an insert-molding method.

10. A wide-band antenna according to claim 1,
wherein said dielectric member is made of a high dielectric constant resin or high dielectric constant ceramics.

11. A wide-band antenna according to claim 1,
wherein said feeder is disposed on the two faces of a supporting member of a flat plate shape such that the feeders on the two faces are connected to each other.

12. A wide-band antenna according to claim 11,
wherein said supporting member is made of a dielectric material.

13. An antenna mounting substrate comprising a wide-band antenna according to claim 1.

14. A wide-band antenna adapted to be mounted on a substrate having a grounding electrode and comprising a feeder,
wherein said feeder including a conductive flat plate of a rectangular shape cut away at its one corner such that said cut-away portion is defined by two sides making an angle, and either one straight line joining said two sides or an arc joining said two sides and bulging inward, and
wherein said feeder is so disposed on the end side of said substrate as to confront either said one straight line or said bulging arc in said cut-away portion with respect to said grounding electrode, such that the distance between said grounding electrode and said feeder becomes the longer as the closer to the end portion of said substrate.

15. A wide-band antenna according to claim 14,
wherein said feeder is covered with a dielectric member of a flat plate shape.

16. A wide-band antenna according to claim 15,
wherein an electric feeding terminal is disposed on one of said angle-making two sides outside of said dielectric member.

17. A wide-band antenna according to claim 16,
wherein said feeding terminal projects normal to the flat face of said dielectric member such that said projecting portion is folded in an L-shape.

18. A wide-band antenna according to claim 17,
wherein fixing terminals are disposed outside of said dielectric member one by one on the two shoulders of the side confronting said one side having said feeding terminal mounted thereon.

19. A wide-band antenna according to claim 18,
wherein said fixing terminals have portions projecting in the same direction and to the same height as those of said feeding terminals and folded in the L-shape.

20. A wide-band antenna according to claim 19,
wherein a projection projecting in the same direction and to the same height as those of said protruding portions is disposed at the portion, as corresponding to said cut-away portion, in said dielectric member.

21. A wide-band antenna according to claim 16,
wherein said feeding terminal extends in parallel with the flat face of said feeder.

22. A wide-band antenna according to claim 14,
wherein said feeder and said dielectric member are molded monolithically with each other by an insert-molding method.

23. A wide-band antenna according to claim 14,
wherein said dielectric member is made of a high dielectric constant resin or high dielectric constant ceramics.

24. A wide-band antenna according to claim 14,
wherein said feeder is disposed on the two faces of a supporting member of a flat plate shape such that the feeders on the two faces are connected to each other.

25. A wide-band antenna according to claim 24,
wherein said supporting member is made of a dielectric material.

26. An antenna mounting substrate comprising a wide-band antenna according to claim 14.
